(19) United States
(12) Patent Application Publication
(10) Pub. No.: US 2025/0001842 A1
(43) Pub. Date: Jan. 2, 2025

(54) SUN VISOR METHOD AND APPARATUS

(71) Applicant: FISKER INC., Manhattan Beach, CA (US)

(72) Inventors: Peter Saglimbene, Manhattan Beach, CA (US); Robert Huotari, Manhattan Beach, CA (US); Peter Corey, Manhattan Beach, CA (US); Vishal Pawar, Manhattan Beach, CA (US); Lawrence Thomas, Manhattan Beach, CA (US); Daniel A. Buccino, Manhattan Beach, CA (US); Don Herner, Manhattan Beach, CA (US)

(21) Appl. No.: 18/709,245

(22) PCT Filed: Nov. 11, 2022
(86) PCT No.: PCT/US2022/079728

§ 371 Date: May 10, 2024

Related U.S. Application Data
(60) Provisional application No. 63/278,986, filed on Nov. 12, 2021.

(51) Int. Cl. B60J 3/02

(52) U.S. Cl. CPC B60J 3/0213; B60J 3/0278

(57) ABSTRACT

A method and apparatus are disclosed. Some embodiments may include a sun visor configured to be received in a closed position within a recess of a head liner of a vehicle, a fastening component at a first edge of a top edge of the sun visor, configured to fasten the sun visor to the body of the vehicle, and to define an axis around which the sun visor is configured to rotate, wherein the sun visor is configured to rotate from the closed position to an open position by rotating toward a user sitting in a seat within the vehicle. The sun visor may include a second edge at an opposite edge of the sun visor with respect to the first edge of the sun visor, wherein when in the closed position the second edge is configured to be disposed at a non-zero angle away from a horizontal plane.

### FIELD OF THE DISCLOSURE

The present disclosure relates to methods for disposing a sun visor, a sun visor apparatus, and the like.

### BACKGROUND

Sun visors may be used in vehicles protect the occupants' eyes from bright sunlight. In some cases, a sun visor may be used by a driver to avoid bright sunlight shining into the driver's eyes while driving the vehicle.

### SUMMARY

One aspect of the present disclosure relates to a method for disposing a sun visor. The method may include disposing a sun visor in a closed position within a recess of a head liner of a vehicle. The method may include disposing a fastening component to a first edge of a top edge of the sun visor to fasten the sun visor to a body of the vehicle. In some cases, the fastening component is configured to define an axis at a first edge of the sun visor and around which the sun visor is configured to rotate and the sun visor may be configured to rotate from the closed position to an open position by rotating toward a user sitting in a seat within the vehicle. The method may include disposing a second edge at a non-zero angle away from a horizontal plane when the sun visor is in the closed position, wherein the second edge is opposite the first edge of the sun visor.

Another aspect of the present disclosure may include an apparatus. The apparatus may include a sun visor configured to be received in a closed position within a recess of a head liner of a vehicle. The apparatus may include a fastening component at a first edge of a top edge of the sun visor. In some cases, the fastening component is configured to fasten the sun visor to the body of the vehicle and may be configured to define an axis at a first edge of the sun visor and around which the sun visor is configured to rotate. The sun visor may be configured to rotate from the closed position to an open position by rotating toward a user sitting in a seat within the vehicle. The sun visor may further include a second edge at an opposite edge of the sun visor with respect to the first edge of the sun visor, wherein when in the closed position the second edge is configured to be disposed at a non-zero angle away from a horizontal plane.

### BRIEF DESCRIPTION OF THE DRAWINGS

FIG. 1 illustrates a method for disposing a sun visor.

FIG. 2 illustrates an apparatus.

FIG. 3 further illustrates the apparatus having fastening components.

FIG. 4 illustrates an example of a fastening component.

FIGS. 5A-5D illustrate an example embodiment of the sun visor movement from a perspective of a user sitting in a driver's seat of the vehicle.

FIGS. 6A-6E illustrate an example embodiment of the sun visor movement from a side perspective of the sun visor.

FIG. 7 illustrates positioning of magnetic elements on the first and second panels of the sun visor.

FIGS. 8A-8E illustrate an example embodiment of the sun visor movement from an exterior perspective view of the sun visor.

FIG. 9 illustrates multiple views of the sun visor.

### DETAILED DESCRIPTION

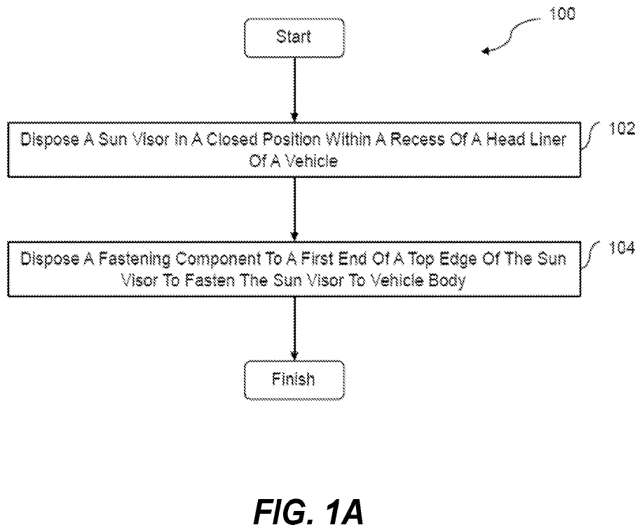

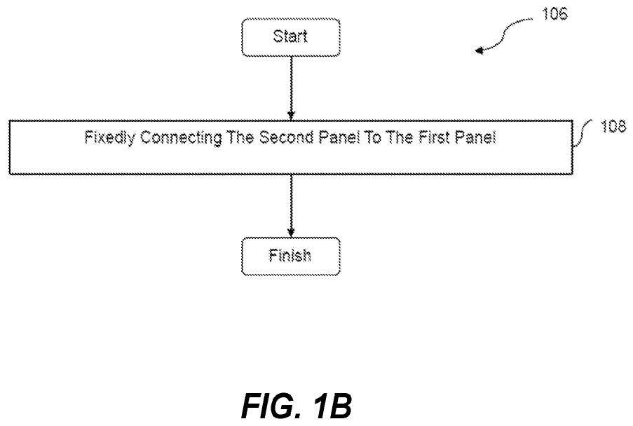

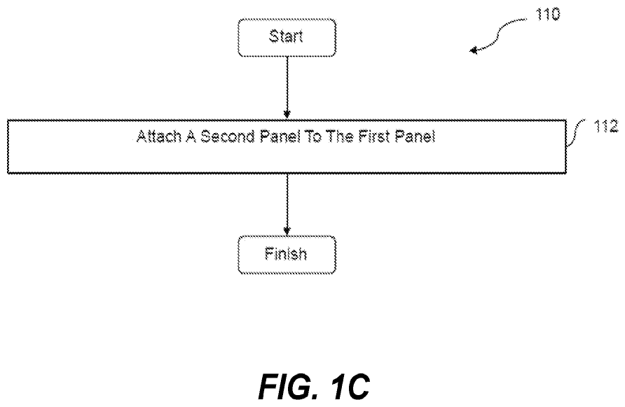

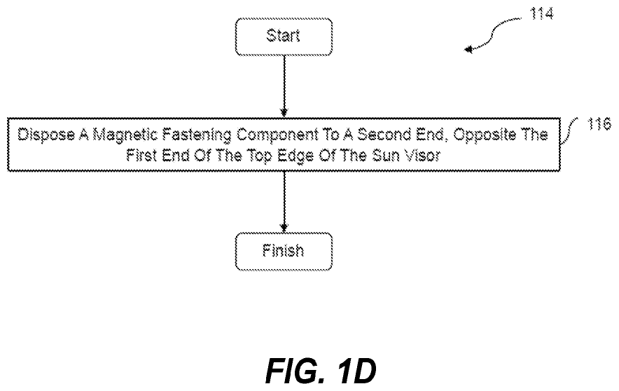

FIGS. 1A, 1B, 1C and/or 1D illustrate an example flow diagram of a method 100, according to one embodiment. The method 100 may include disposing a sun visor in a closed position within a recess of a head liner of a vehicle at block 102. The method 100 may include disposing a fastening component to a first edge of a top edge of the sun visor to fasten the sun visor to the body at block 104, the fastening component is configured to connect to a rod defining an axis at a first edge of the sun visor and around which the sun visor is configured to rotate, when in the closed position the sun visor is configured to rotate away from a user of a vehicle sitting in a seat within the vehicle, and disposing a second edge being at an opposite edge of the sun visor with respect to the first edge of the sun visor, when in the closed position the second edge being disposed at a non-zero angle away from a horizontal plane and the horizontal plane intersects with the first edge.

In FIG. 1B, the method 100 may be continued at 106, and may further include fixedly connecting the second panel to the first panel at block 108. The second panel comprises an outward facing side and an inward facing side. The inward facing side of the second panel is configured to be relatively adjacent to the inward facing side of the first panel when in a closed position in relation to the outward facing side of the second panel, and the outward facing side is configured to be relatively adjacent to the windshield of the vehicle when in an open position relative to the inward facing side of the second panel.

In FIG. 1C, the method 100 may be continued at 110, and may further include attaching a second panel to the first panel at block 112. In some cases, a first edge of the second panel is convex shape, and the interface between the concave shape and the convex shape forms an interface between the second edge of the first panel and the first edge of the second panel.

In FIG. 1D, the method 100 may be continued at 114, and may further include disposing a magnetic fastening component to a second edge, opposite the first edge of the top edge of the sun visor at block 116. In some cases, the magnetic fastening component is configured to fasten the sun visor to the head liner and/or a body of the vehicle on a side nearest to the center rearview mirror when in comparison to the fastening component on the first edge of the top edge of the sun visor. In some cases, the first edge of the top edge of the sun visor is relatively closer to an A column of the vehicle when in comparison to the second edge.

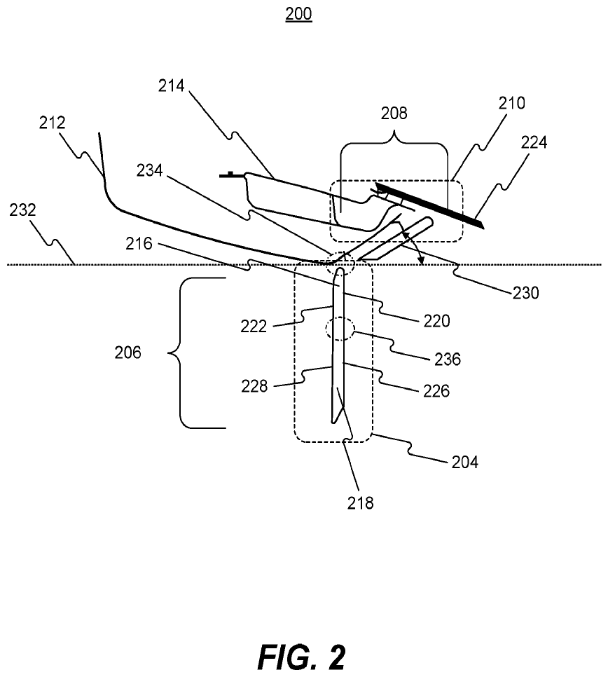

FIG. 2 illustrates an apparatus. The apparatus 200 may include a sun visor 204, generally indicated by the dashed area 204 in an open position, generally indicated by the bracket 206. The sun visor 204 may be configured to be received in a closed position, generally indicated by the bracket 208, within a recess, generally indicated by the dashed area 210 of, and/or defined by, a head liner 212 of a vehicle.

In some cases, the vehicle may include a front header 214. The front header may be a part of the body of the vehicle, or body in white. In either case, the sun visor 204 may be configured to be received into the recess 210 defined by the headliner (either a wider profile head liner 212 or the thinner headliner 214).

In some cases, the sun visor 204 comprises a first panel 216 and a second panel 218. The first panel 216 comprises an outward facing side 220 and an inward facing side 222. As illustrated in FIG. 2, the outward facing side 220 of the first panel is configured to be relatively adjacent to one or more of a windshield 224 of the vehicle, the recess 210, or any combination thereof when in the closed position 208 in relation to the inward facing side 222 of the first panel 216. When in the closed position 208, the sun visor 204 is configured to be received into the recess 210.

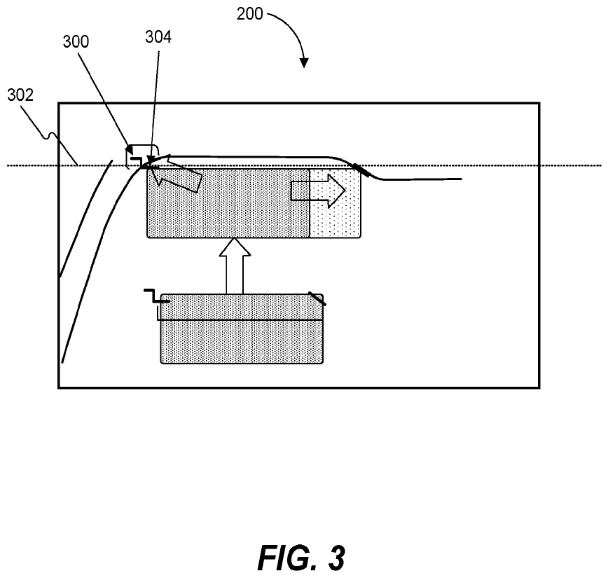

As discussed in more detail below in reference to FIG. 3, the second panel 218 may be fixedly or detachably attached to the first panel 216. Referring back to FIG. 2, the second panel 218 comprises an outward facing side 226 and an inward facing side 228, the inward facing side 228 of the second panel 218 is configured to be relatively adjacent to the inward facing side 222 of the first panel 216 when in the closed position in relation to the outward facing side 226 of the second panel 218. In some cases, the outward facing side 226 of the second panel 218 may be configured to be relatively adjacent to the windshield 224 of the vehicle when in an open position 206 relative to the inward facing side 228 of the second panel.

As further illustrated in FIG. 2, when in a closed position 208, the sun visor 204 may be disposed at an angle 230 relative to a horizontal plane, such as the horizontal plane indicated by dashed line 232. In some cases, the angle 230 is a non-zero angle. As indicated in FIG. 2, the first panel 216 may include a first edge 234 and a second edge 236 that is on an opposite side of the first panel 216 in relation to the first edge 234. When in the closed position 208 the second edge 236 may be disposed at a non-zero angle, such as the angle 230 away from the horizontal plane 232.

In some cases, the horizontal plane 232 intersects with the first edge 234. In some cases, the horizontal plane 232 is defined as being one or more of: substantially orthogonal to a plane associated with gravity or substantially orthogonal to a vertical “z” axis associated with a plane of gravity. In some cases, the sun visor 204 may be considered more like an extension of the head liner rather than a sun visor as it unfolds outwards from the recess defined by the headliner to extend the reach of the headliner.

FIG. 3 further illustrates the apparatus having fastening components. For example, the apparatus 200 may include a fastening component 300 at the first edge 234 discussed in relation to FIG. 2. The first edge 234 may be a top edge of the sun visor 204 in relation to a bottom edge, such as the second edge 236 of the sun visor 204 in FIG. 2. In FIG. 3, the fastening component may be configured to fasten the sun visor 204 to the body of the vehicle. In some cases, the fastening component 300 may define an axis 302 around which the sun visor 204 is configured to rotate. In some case, the fastening component is configured to connect to a rod 304 at least partially defining the axis at the first edge 234 of the sun visor 204 and around which the sun visor is configured to rotate. The first edge 234 may be defined as the edge of the first panel 216 wherein when in the closed position the sun visor is configured to rotate away from a user of a vehicle sitting in a seat within the vehicle. In some cases, an as illustrated in FIG. 3 and further Figures below, the first edge 234 may be a curved edge to interface with a reciprocal edge of the head liner 212. The sun visor 204 may further include the second edge 236, at an opposite edge of the sun visor 204 with respect to the first edge 234 of the sun visor 204, wherein when in the closed position 208 the second edge 236 is configured to be disposed at the non-zero angle 230 away from the horizontal plane 232, as shown in FIG. 2. In some cases, as illustrated in FIG. 3, the sun visor 204 may be configured to have a spring-loaded component to provide force in the direction of the rear review mirror when disposed in the front facing position. Further, in some cases, the fastening component 300 may be configured to enable the sun visor 204 to be rotated away from the windshield and disposed relatively closer to the driver's side window so as to block sunlight and/or glare entering through the driver's side window of the vehicle.

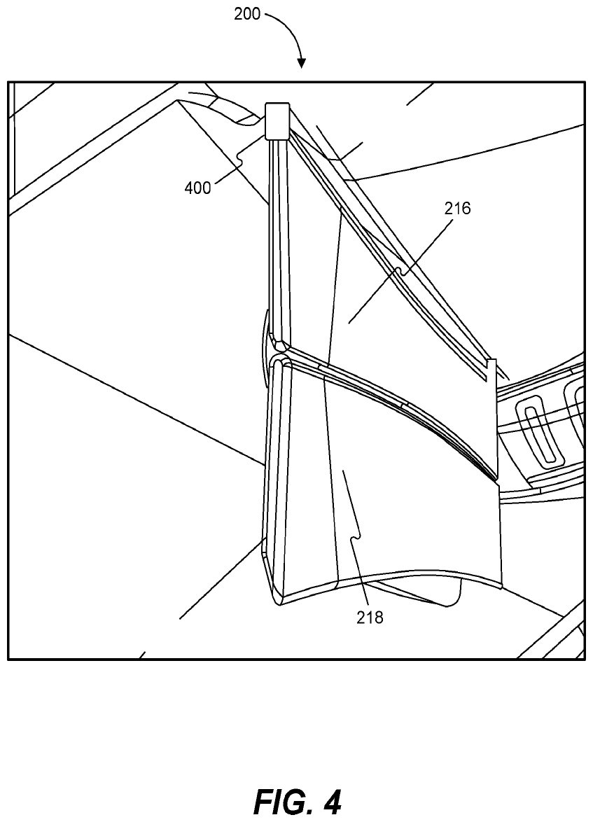

FIG. 4 illustrates an example of a fastening component, such as the fastening component 300 in FIG. 3. In FIG. 4, the example fastening component of the apparatus 200 is shown at 400. The example fastening component 400 may include or be attached to a swivel to enable rotation of the sun visor 204. In some cases, as illustrated FIG. 4 and in further detail below, the second edge 236 of the first panel 216 is concave in shape. In this scenario, when the second panel 218 is connected or attached to the first panel 216, a first edge of the second panel 218 is convex shape, and the interface between the concave shape of the second edge 236 and the convex shape of a first edge of the second panel 218 forms a curved interface. Further, the second edge of the second panel 218 may also be concave to enable the second edge to interface with a convex edge of the headliner when in the closed position 208 illustrated in FIG. 2.

In some cases, and as illustrated in FIG. 4, the first panel 216 and the second panel 218 may be attached to each other. In some scenarios there may be a material used to connect the first panel 216 to the second panel 218 which can at least partially block sunlight traversing through an interface formed between the first panel 216 and the second panel 218. As further illustrated in FIG. 4, while one end of the first panel may be configured with an attachment configured to be attached to the body of the vehicle, an opposite end may be configured to have a magnetic attachment for removably attaching to the body of the vehicle using a ferromagnetic material to receive the magnetic attachment. The magnetic attachment may be referred to herein as a magnetic fastening component. The magnetic attachment is only one example of an attachment that may be used. In some cases, the first panel may be attached to the headliner, the head mounting, or any other component via a fastener more akin to a standard visor catch interface such as a hook or latch enabled to receive a bar or a rod within the hook.

As illustrated in FIG. 4, the first panel 216 and second panel 218 may be configured to move between the closed position 208 discussed in regard to FIG. 2, to the open position 206 by a user of the vehicle pulling on a second edge of the second panel when the first and second panel are in the closed position.

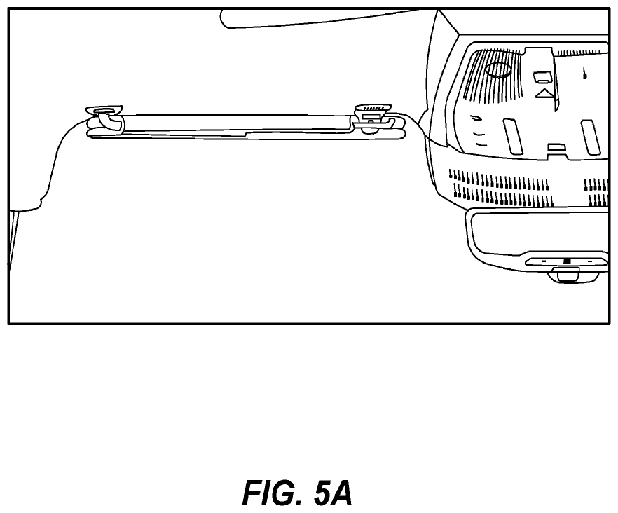

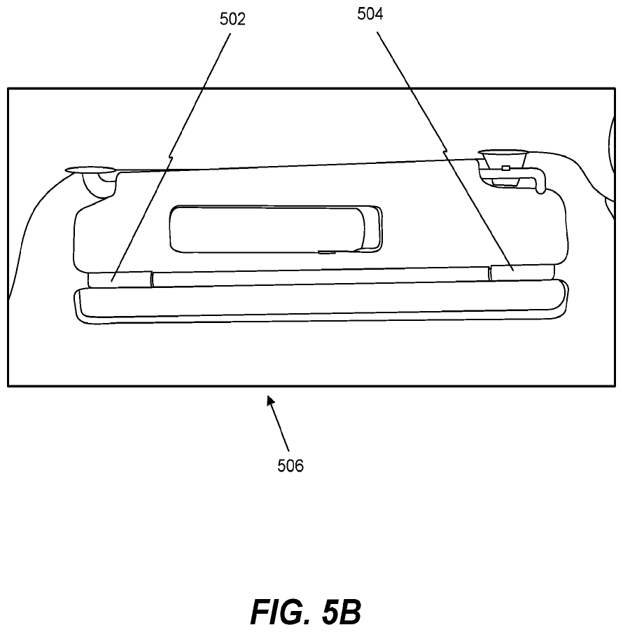

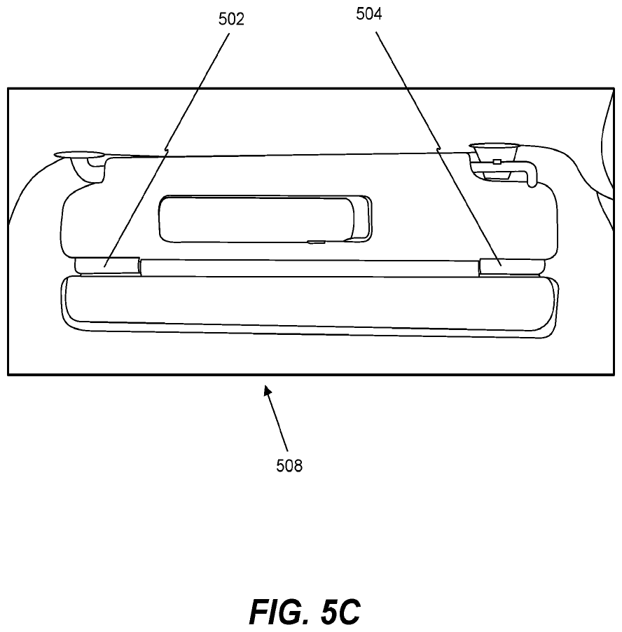

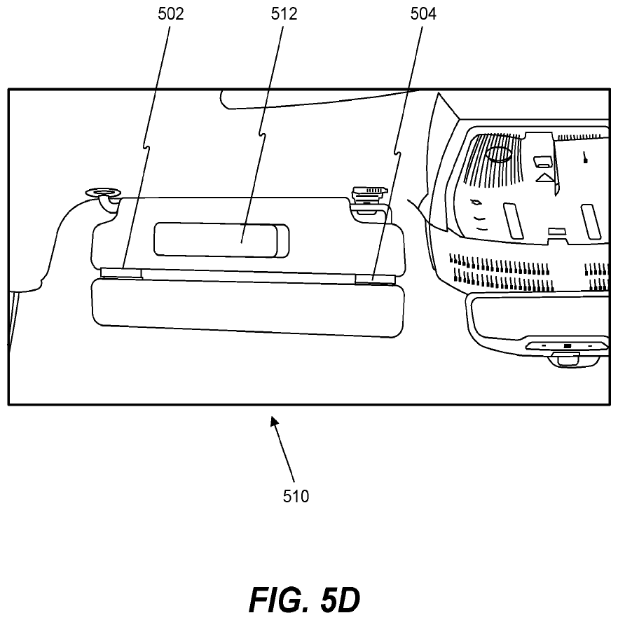

FIGS. 5A-5D illustrate an example embodiment of the sun visor movement from a perspective of a user sitting in a driver's seat of the vehicle. For example, FIG. 5A illustrates a partial unfolding of a sun visor, such as the sun visor 204 of FIG. 2. The sun visor may be configured to unfold in an accordion-like fashion as illustrated in FIGS. 5A-5D. As further illustrated in FIGS. 5A-5D, the first panel 216 and second panel 218 may be configured to be attached by attachments, such as the attachments illustrated at 502 and 504. The accordion-like fashion of unfolding can be seen through the progression of positions at 506-510, as well as folding by reversing the order of positions by going from positions 510-506 from FIGS. 5D-5A. The accordion-like fashion movement when opening is configured to have the first panel 216 and second panel 218 move forward toward the user and away from the windshield. In contrast, when the accordion like movement is occurring during closing the sun visor 204 panels 216 and 218 move away from the user towards the windshield into the recess 210 defined by the head liner 212 discussed previously in regard to FIG. 2. Referring to FIG. 5A, the sun visor 204 may be configured to recede into a depression or recess, such as the recess 210 of FIG. 2. In FIG. 5A, the apparatus 200 is illustrated as receding into the recess 210 at least partially removing the sun visor from the field of view of a user viewing out the windshield toward the front of the vehicle.

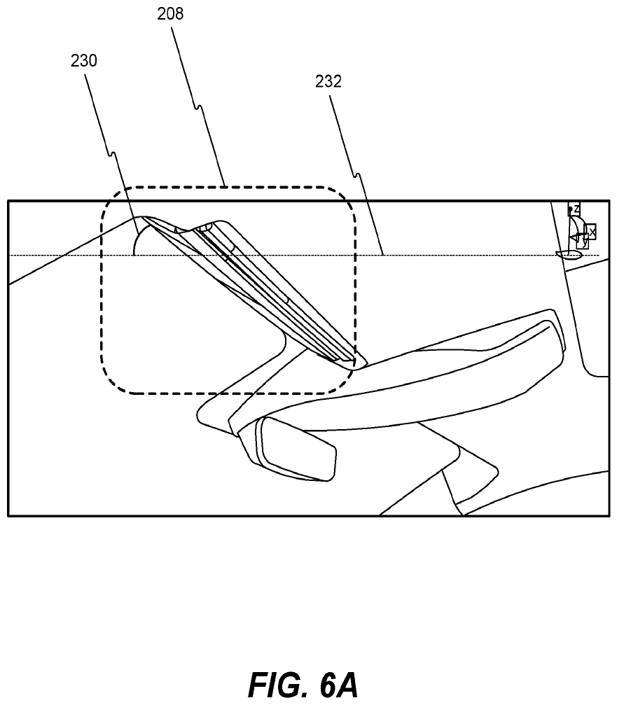

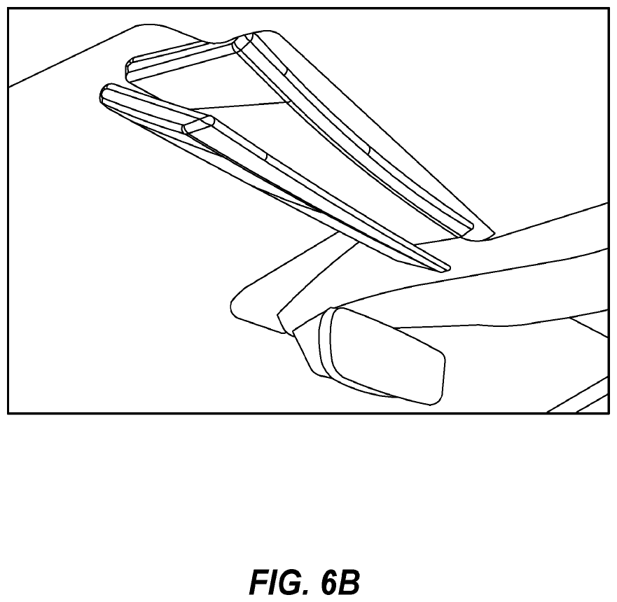

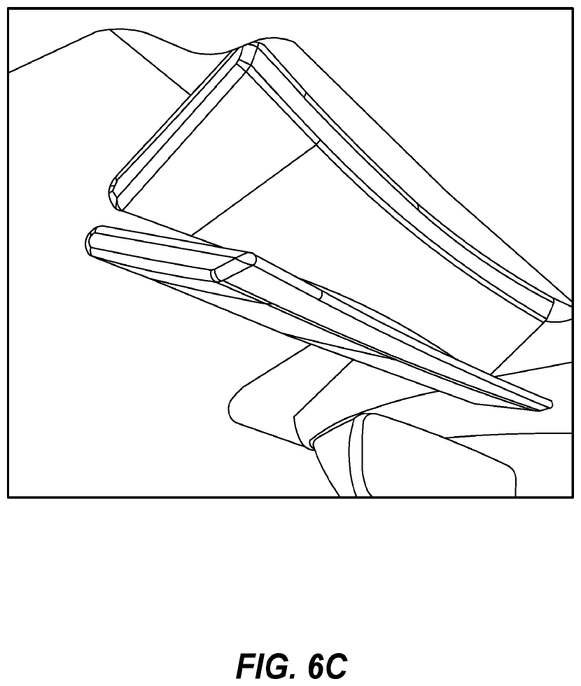

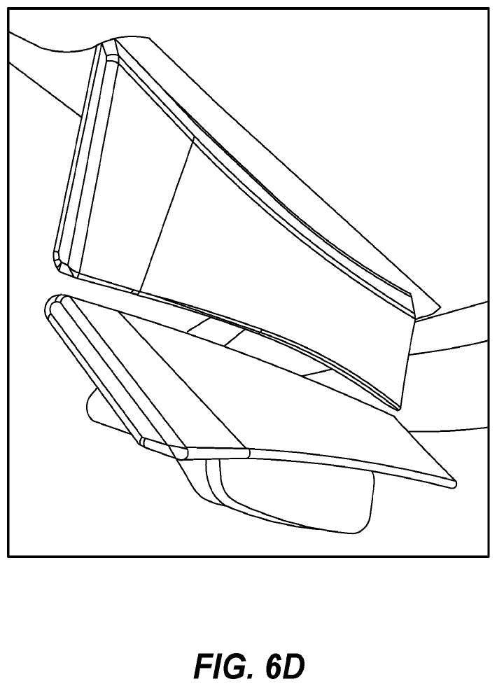

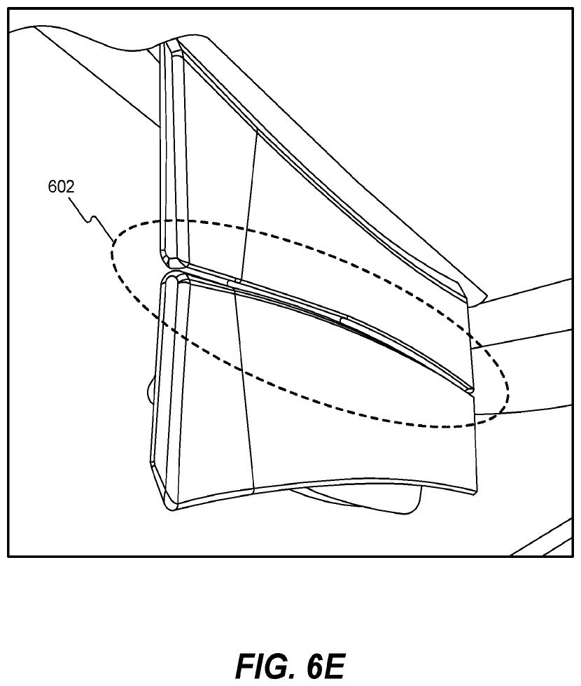

FIGS. 6A-6E illustrate an example embodiment of the sun visor movement from a side perspective of the sun visor. As illustrated in FIG. 6A, when in the closed position, such as the closed position 208 discussed above in reference to FIG. 2, and shown generally by FIG. 6A and by the dashed box at 208, the sun visor 204 is configured to be received into a recess defined by and/or within the head liner 212. When in this closed position 208, the first panel 216 and second panel 218 are configured to be disposed at the non-zero angle 230 illustrated in both FIG. 2 and FIG. 6A. The non-zero angle 230 is in relation to the horizontal plane illustrated by the dotted like 232 of FIG. 2 and FIG. 6A.

As further illustrated by FIGS. 6A-6E sun visor 204 is configured to unfold in an accordion-like manner away from the recess defined by the head liner, such as the recess 210 previously discussed in reference to FIG. 2 and as generally illustrated in FIGS. 6A-6E. Further, as previously discussed in reference to FIG. 4, the interface 602 between the first panel 216 and the second panel 218 may be a curved interface as illustrated in FIG. 6E.

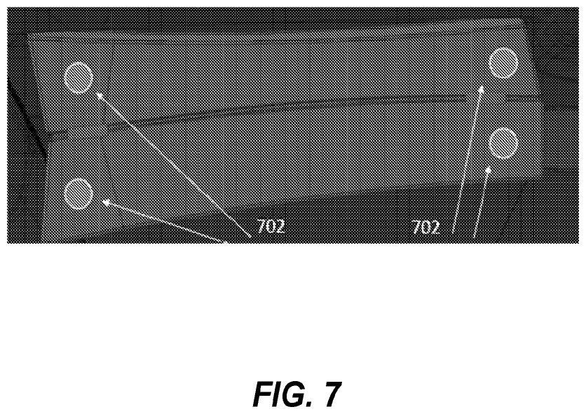

FIG. 7 illustrates positioning of magnetic elements on the first and second panels of the sun visor. The first panel 216 may include one or more magnetic elements (702) configured to be attracted to one or more magnetic elements in the second panel 218. The one or more magnetic elements in each of the first or second panel may include a magnetic pair of magnetic elements, one on each panel wherein a magnetic pair may include a first ferromagnetic material on one panel (216 or 218) with a second ferromagnetic material on the other panel. For example, one side of a magnetic pair may include a magnet while the other side may be equipped with a ferro metal. As another example, one side may include a magnet while the other side may include an oppositely polarized magnet. The one or more magnetic elements in each panel may be configured to hold the first panel 216 to the second panel 218 when in a closed position. In some cases, the one or more magnetic elements in each panel may be configured to hold second panel 218 to the first panel 216 even when the first panel is in an open position while the second panel 218 is magnetically attached to the first panel 216 to reduce the size of the sun visor 204 when in use based on user preference. Magnetic attachment is only one example embodiment of attaching the first panel 216 to the second panel 218 and other embodiments are considered. For example, the first panel 216 and second panel 218 may be configured to be attached by another attachment means on the face of one or more panels such as a pin in one panel and locking hole defined in another panel. In other cases, the panels may be configured to be attached to each other by a hook and loop connection system on the one or more faces of each panel.

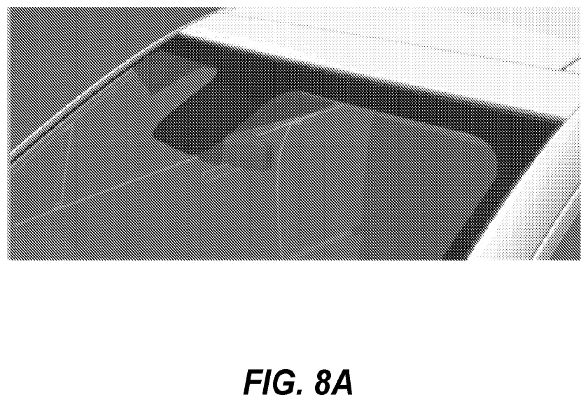

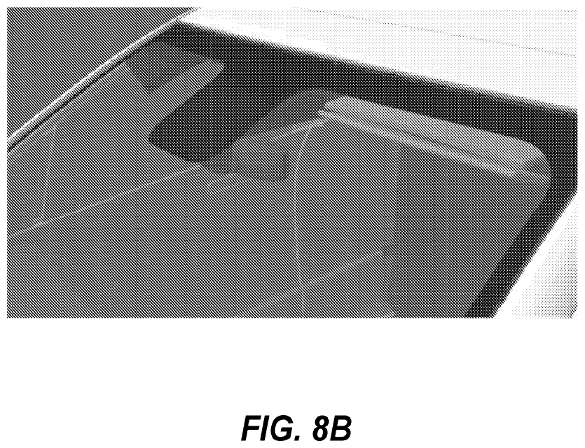

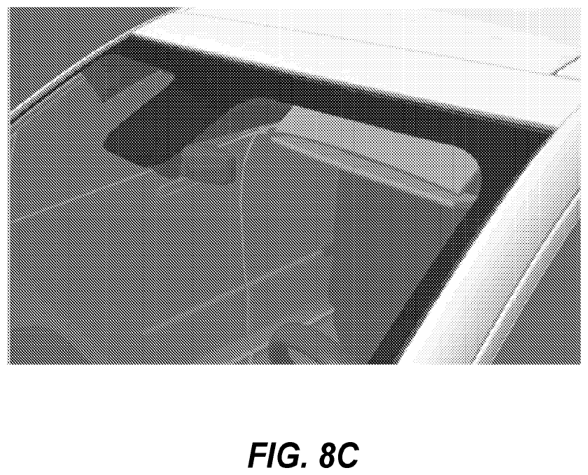

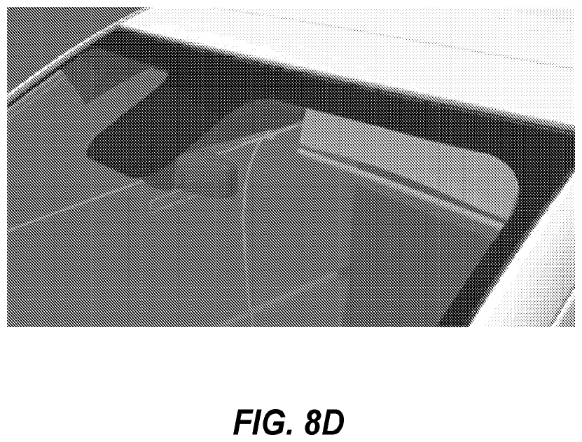

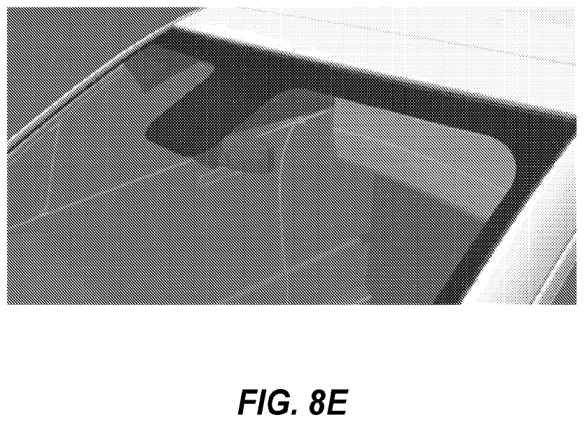

FIGS. 8A-8E illustrate an example embodiment of the sun visor movement from an exterior perspective view of the sun visor. As illustrated in FIG. 8A, when in a closed position, such as the closed position 208 discussed previously regarding FIG. 2, the sun visor 204 may be configured to recede into a recess within the head liner 212 enabling the sun visor 204 to substantially out of the line of vison of the user through the windshield of the vehicle. The accordion-like unfolding of the first and second panel (216 and 218) of the sun visor 204 enable the sun visor 204 to be extended into a larger area in relation to a sun visor having only one panel. Further, the arrangement as illustrated in FIGS. 8A-8E as well as elsewhere herein, enables a user to close the multi-panel sun visor by pushing the sun visor 204 forward/outward (in relation to the user and/or the interior of the vehicle) and up into the recess defined by the head liner 212, rather than being towards the user and up.

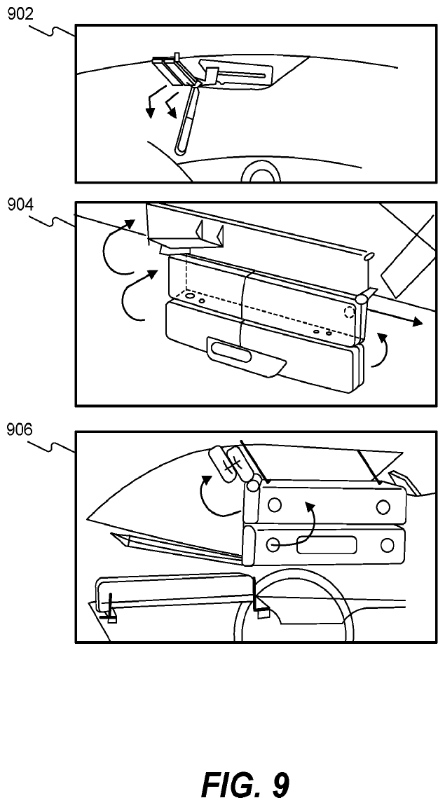

FIG. 9 illustrates multiple views of the sun visor. For example, at 902, the sun visor 204 is illustrated from a side view. At 904 the sun visor 204 is illustrated at a perspective view with arrows indicating how the sun visor 204 may fold together in an accordion-like fashion. At 906 the sun visor 204 is illustrated at another perspective view with the second panel 218 being folded up and magnetically attached to the first panel 216 without folding the first panel 216 into the recess 210 defined by the head liner 212.

In some cases the sun visor may include a mirror (512) and a mirror light that can be turned on and off via a capacitive touch sensor. In some cases the mirror light may be activated or deactivated by a sliding or rotating vanity door cover. In this case, the activation or deactivation may be carried out via capacitive sensors in the mirror with related sensors configured to trigger the activation and/or deactivation of the mirror light in the sliding vanity door and/or rotating vanity door.

Further, in some cases, motion of the sun visor on either the upper or lower panel may be rotated into a number of predefined positions wherein one or both panels will be held stationary. These predefined positions may enable the sun visor panels to be held in the predefined positions, in some cases, by a detent. In some cases, the sun visor and/or the upper and/or lower panel may be configured to be rotated into an infinite number of positions wherein the panels will be held stationary by an interference. In this example, the interference may enable either the upper panel, the lower panel, or both to retain the last position the occupant/driver/user desired.

Further, in some cases the motion of the upper, the lower, and/or a combination of these panels can be toward or away from the occupant/driver/user and can be done in one motion, by moving or rotating either of the two panels independently, or any combination thereof.

The examples provided below are illustrative of numerous combinations of elements and features that are contemplated herein. Example 1 includes a method comprising: disposing a sun visor in a closed position within a recess of a head liner of a vehicle and disposing a fastening component to a first edge of a top edge of the sun visor to fasten the sun visor to the body of the vehicle.

Example 2 includes the method of example(s) 1 and/or some other example(s) herein, wherein the horizontal plane is defined as being one or more of: substantially orthogonal to a plane associated with gravity; or substantially orthogonal to a vertical “z” axis associated with a plane of gravity.

Example 3 includes the method of example(s) 1 and/or some other example(s) herein, wherein the sun visor comprises a first panel and a second panel, the first panel comprises an outward facing side and an inward facing side, and the outward facing side of the first panel is configured to be relatively adjacent to one or more of a windshield of the vehicle, the head liner recess, or any combination thereof when in a closed position in relation to the inward facing side of the first panel.

Example 4 includes the method of example(s) 3 and/or some other example(s) herein, further comprising: fixedly connecting the second panel to the first panel, wherein the second panel comprises an outward facing side and an inward facing side, the inward facing side of the second panel is configured to be relatively adjacent to the inward facing side of the first panel when in a closed position in relation to the outward facing side of the second panel, and the outward facing side is configured to be relatively adjacent to the windshield of the vehicle when in an open position relative to the inward facing side of the second panel.

Example 5 includes the method of example(s) 1 and/or some other example(s) herein, further comprising: attaching a second panel to the first panel, wherein a first edge of the second panel is convex shape, and the interface between the concave shape and the convex shape forms an interface between the second edge of the first panel and the first edge of the second panel.

Example 6 includes the method of example(s) 5 and/or some other example(s) herein, wherein the first and second panel are configured to move between the closed position to an open position by the user of the vehicle pulling on a second edge of the second panel when the first and second panel are in a closed position to unfold in an accordion-like fashion.

Example 7 includes the method of example(s) 1 and/or some other example(s) herein, further comprising: disposing a magnetic fastening component to a second edge, opposite the first edge of the top edge of the sun visor, wherein the magnetic fastening component is configured to fasten the sun visor to the body of the vehicle.

What is claimed is:

1. A method, comprising:
disposing a sun visor in a closed position within a recess defined by a head liner of a vehicle;
disposing a fastening component to a first edge of a top edge of the sun visor to fasten the sun visor to a body of the vehicle, the fastening component defining an axis around which the sun visor is configured to rotate, wherein the sun visor is configured to rotate from the closed position to an open position by rotating toward a user sitting in a seat within the vehicle; and
disposing a second edge at a non-zero angle away from a horizontal plane when the sun visor is in the closed position, wherein the second edge is opposite the first edge of the sun visor.

2. The method of claim 1, wherein the horizontal plane intersects with the first edge and wherein the horizontal plane is defined as being one or more of:
substantially orthogonal to a plane associated with gravity; or
substantially orthogonal to a vertical axis associated with a plane of gravity.

3. The method of claim 1, wherein the sun visor comprises a first panel and a second panel, wherein the first panel comprises an outward facing side and an inward facing side, and wherein the outward facing side of the first panel is configured when in the closed position in relation to the inward facing side of the first panel to be relatively adjacent to a windshield of the vehicle or the recess defined by the head liner.

4. The method of claim 3, further comprising fixedly connecting the second panel to the first panel, wherein the second panel comprises an outward facing side and an inward facing side, the inward facing side of the second panel is configured to be relatively adjacent to the inward facing side of the first panel when in the closed position in relation to the outward facing side of the second panel, and the outward facing side of the second panel is configured to be relatively adjacent to the windshield of the vehicle when in an open position relative to the inward facing side of the second panel.

5. The method of claim 3, wherein the second edge of the first panel is concave in shape, further comprising attaching the second panel to the first panel, wherein a first edge of the second panel is convex in shape, and an interface between the concave shape and the convex shape forms a curved interface between the second edge of the first panel and the first edge of the second panel.

6. The method of claim 5, wherein the first and second panels are configured to move between the closed position to an open position by the user of the vehicle pulling on a second edge of the second panel when the first and second panels are in the closed position to unfold in an accordion-like fashion.

7. The method of claim 1, further comprising disposing a magnetic fastening component to the second edge, wherein the magnetic fastening component is configured to fasten the sun visor to the body of the vehicle.

8. An apparatus, comprising:
a sun visor configured to be received in a closed position within a recess of a head liner of a vehicle; and
a fastening component at a first edge of a top edge of the sun visor, wherein the fastening component is configured to fasten the sun visor to a body of the vehicle, wherein the fastening component is configured to define an axis around which the sun visor is configured to rotate, wherein the sun visor is configured to rotate from the closed position to an open position by rotating toward a user sitting in a seat within the vehicle, wherein the sun visor comprises a second edge opposite the first edge of the sun visor, wherein when in the closed position the second edge is configured to be disposed at a non-zero angle away from a horizontal plane, and wherein the horizontal plane intersects with the first edge.

9. The apparatus of claim 8, wherein the horizontal plane intersects with the first edge and wherein the horizontal plane is defined as being one or more of:
substantially orthogonal to a plane associated with gravity; or
substantially orthogonal to a vertical axis associated with a plane of gravity.

10. The apparatus of claim 8, wherein the sun visor comprises a first panel and a second panel, wherein the first panel comprises an outward facing side and an inward facing side, and wherein the outward facing side of the first panel when in the closed position in relation to the inward facing side of the first panel is configured to be relatively adjacent to a windshield of the vehicle or the head liner recess.

11. The apparatus of claim 10, wherein the second panel is attached to the first panel, wherein the second panel comprises an outward facing side and an inward facing side, the inward facing side of the second panel is configured to be relatively adjacent to the inward facing side of the first panel when in the closed position in relation to the outward facing side of the second panel, and the outward facing side of the second panel is configured to be relatively adjacent to the windshield of the vehicle when in an open position relative to the inward facing side of the second panel.

12. The apparatus of claim 10, wherein the second edge of the first panel is concave in shape, further comprising attaching the second panel to the first panel, wherein a first edge of the second panel is convex in shape, and an interface between the concave shape and the convex shape forms a curved interface between the second edge of the first panel and the first edge of the second panel.

13. The apparatus of claim 12, wherein the first and second panels are configured to move between the closed position to an open position by the user of the vehicle pulling on a second edge of the second panel when the first and second panels are in the closed position to unfold in an accordion-like fashion.

14. The apparatus of claim 8, further comprising a magnetic fastening component disposed at the second edge, wherein the magnetic fastening component is configured to fasten the sun visor to the body of the vehicle.
